(19) United States
(12) Patent Application Publication
(10) Pub. No.: US 2026/0122393 A1
(43) Pub. Date: Apr. 30, 2026

(54) HEADSET DETACHABLE MICROPHONE WITH MUTE UNMUTE

(71) Applicant: Dell Products L.P., Round Rock, TX (US)

(72) Inventors: Wong Hin Loong Justin, Singapore (SG); I-Tien Hsieh, Taipei City (TW); Choon Lim Lee, Singapore (SG)

(73) Assignee: Dell Products L.P., Round Rock, TX (US)

(21) Appl. No.: 18/932,823

(22) Filed: Oct. 31, 2024

(51) Int. Cl. H04R 1/10; H04R 1/08

(52) U.S. Cl. CPC H04R 1/1041; H04R 1/08; H04R 1/1008; H04R 1/1075; H04R 2201/107; H04R 2430/01

(57) ABSTRACT

An information handling system interfaces with a headset to play information at a speaker earcup as audible sounds and to capture audible sounds with a microphone in a boom. The microphone boom has a key member at the microphone jack that inserts into a key slot of the speaker earcup near the microphone jack receptacle and engages in a key member guide of the speaker earcup to retain the microphone boom in position. A mute sensor monitors the microphone boom rotational orientation to mute and unmute the microphone.

### BACKGROUND OF THE INVENTION

### Field of the Invention

The present invention relates in general to the field of information handling system audio systems, and more particularly to an information handling system headset detachable microphone with mute unmute.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems process information with processor that executes instructions in cooperation with a memory that stores the instructions and information. Stationary information handling systems, such as desktops, have a stationary housing that uses external power and peripheral devices, such as peripheral display, peripheral keyboard and peripheral mouse. Portable information handling systems integrate processing components, a display and a power source in a portable housing to support mobile operations. Portable information handling systems allow end users to carry a system between meetings, during travel, and between home and office locations so that an end user has access to processing capabilities while mobile. Portable information handling systems also typically work with peripheral devices, such as by interfacing with the peripheral devices through cables, WIFI or a docking station.

One common function for information handling systems is communication through videoconferencing and gaming applications. Portable information handling systems often integrate a camera and microphone to capture audiovisual information of an end user for videoconferencing. Portable and stationary information handling systems also typically capture audiovisual information with peripheral devices, such as a peripheral camera and a peripheral microphone. In particular, gamers who play networked games that include audio interfaces will participate in conversations using a headphone having an attached microphone. The headphones have earcups to isolate the end user's hearing to the game audio, which can support multiple gamers playing in the same area. The headset can include a hidden microphone to capture audio and also a microphone boom that lowers to the end user's mouth to directly capture audio with improved focus on the end user's spoken words. In some cases, the microphone boom is detachable so the end user can remove it when it is not needed.

A number of difficulties can arise with the use of a headset having a detachable microphone. One difficulty is that the standard 3.5 mm audio male plug will sometimes come loose or fall out of the headset female jack. When a microphone jack only partially unplugs the end user may lose audio without an indication of the reason for the failure, resulting in difficulty fixing the problem. Another difficulty can arise when the end user wants to mute the microphone. Unplugging the microphone jack may result in an information handling system reverting to an integrated microphone. Interacting with the information handling system to select mute takes time and removes the end user's attention from the tasks at hand.

### SUMMARY OF THE INVENTION

Therefore, a need has arisen for a system and method which manages a headset boom microphone.

In accordance with the present invention, a system and method are provided which substantially reduce the disadvantages and problems associated with previous methods and systems for managing operation of a headset microphone boom. The microphone boom terminates with a key member that fits into a key slot of the headset speaker earcup and rotates within the speaker earcup interior to capture the microphone boom. A mute sensor within the speaker earcup monitors the key member rotational orientation to command mute and unmute of the microphone.

More specifically, an information handling system executes instructions with a processor in cooperation with a memory, such as a gaming application or videoconferencing application that uses audio information. Audio information is presented as audible sounds at a headset having speaker earcups that play the audio to an end user ear. A microphone jack receptacle in a speaker earcup accepts a microphone jack of a microphone on a boom that lowers to a position at the end user's mouth. A key member located near the jack aligns with a key slot of the speaker earcup to accept the microphone jack in the microphone jack receptacle. When the microphone boom is rotated to a lower position, the key member engages in the speaker earcup to retain the microphone boom to the speaker earcup. A mute sensor monitors the key member position to command mute and unmute of the microphone based upon the rotational orientation of the microphone boom.

The present invention provides a number of important technical advantages. One example of an important technical advantage is that a microphone jack couples into a speaker earcup with a key member engaged in the speaker earcup to prevent the microphone jack from disconnecting when the microphone boom is in an unmute position. An end user controls mute and unmute by rotating the microphone boom to a lowered position to unmute the microphone and to a raised position to mute the microphone.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a portable information handling system with a number of peripherals including a headset having a microphone boom;

FIGS. 2 and 2A depict a side perspective and detailed view of the microphone boom aligned to insert a key into a key slot to rotationally affix the boom to the headset;

FIG. 3 depicts an interior perspective detailed view of the speaker earcup with microphone jack 70 fully inserted into the microphone jack receptacle;

FIG. 4 depicts a side view of an example embodiment having the key member leveraged to detect microphone boom rotational orientation to command mute and unmute;

FIGS. 5A, 5B and 5C depict side views of activation of the leaf switch by engagement of leaf switch lever with the key member;

FIG. 6 depicts a top view of an alternative embodiment for monitoring microphone boom position to manage microphone mute and unmute with an optical sensor;

FIG. 7 depicts a top view of an alternative embodiment for monitoring microphone boom position to manage microphone mute and unmute with a magnet and a Hall sensor; and

FIG. 8 depicts a logical block circuit diagram of cooperation of components in the information handling system and headset to manage microphone mute and unmute.

### DETAILED DESCRIPTION

An information handling system presents audio at a headset having a microphone boom with a keyed coupling arrangement monitored to command mute and unmute. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

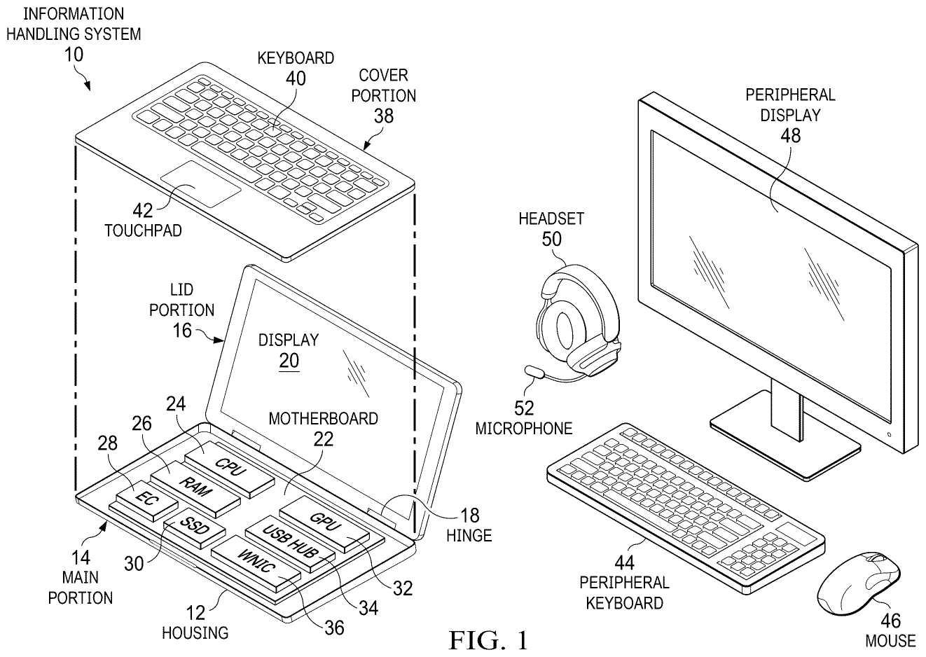

Referring now to FIG. 1, a portable information handling system 10 is depicted with a number of peripherals including a headset having a microphone 52 coupled to a boom. Information handling system 10 is built in a portable housing 12 having a main portion 14 rotationally coupled to a lid portion 16 by a hinge 18. A display 20 couples in lid portion 16 to present information as visual images. A motherboard 22 couples in main portion 14 and interfaces processing components that cooperate to process information. For example, a central processing unit (CPU) 24 executes instructions that process information in cooperation with a random access memory (RAM) 26 that stores the instructions and information. An embedded controller 28 manages operating conditions, such as application of power and interactions with peripheral devices. A solid state drive (SSD) 30 provides persistent storage of instructions and information, such as an operating system and applications that execute on CPU 24. A graphics processing unit (GPU) 32 interfaces with CPU 24 to process information for visual presentation, such as by defining pixels for presentation at display 20. A USB hub 34 communicates with external devices through USB ports and a wireless network interface controller (WNIC) 36 supports wireless communication, such as through WIFI and BLUETOOTH.

Portable information handling system 10 has an integrated keyboard 40 and touchpad 42 that couple to a housing cover portion 38 coupled over housing main portion 14. In addition, portable information handling system 10 interfaces with a number of peripheral devices through USB cables or wireless signals. A peripheral display 48 presents information as visual images. A peripheral keyboard 44 and mouse 46 accept end user inputs and communicate the inputs to the CPU through the embedded controller. A headset 50 receives audio information from information handling system 10 and presents the audio information as audible sounds at a speaker in each of two speaker earcups. A microphone 52 couples to headset 50 with a boom that holds the microphone at the mouth of an end user wearing the headset with each speaker earcup placed over the end user's ears. Audible sounds captured by the microphone are converted into digital information that is communicated to information handling system 10. For instance, an end user voice is captured to support videoconferencing or gaming applications. In the example embodiment, the microphone boom connects and disconnects with a jack that inserts into a jack receptacle. The jack receptacle and boom are held in place with a key and key slot interaction. The rotational orientation of the boom is monitored to mute and unmute microphone 52

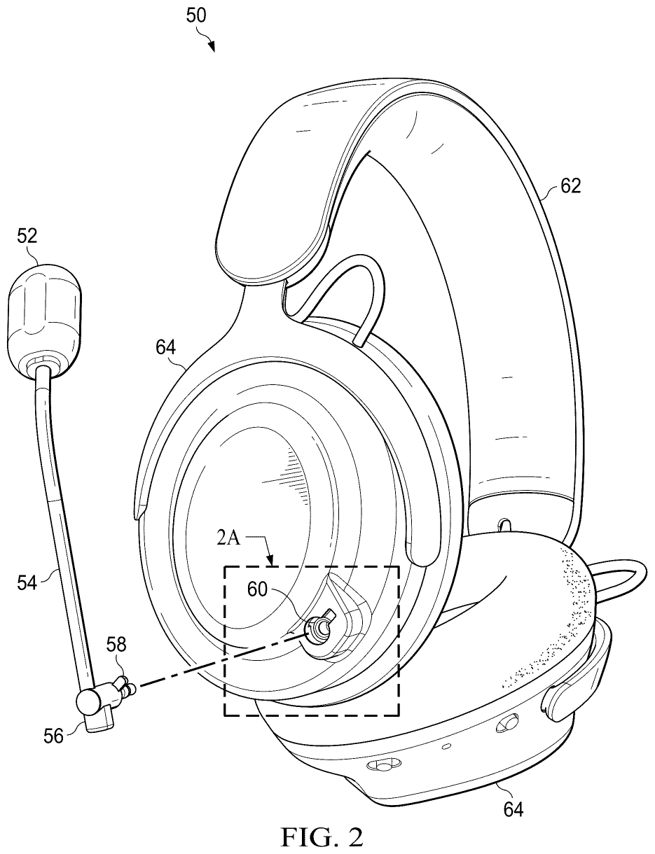

Referring now to FIGS. 2 and 2A, side perspective and detailed views depict microphone boom 54 aligned to insert a key 58 into a key slot to rotationally affix the boom to the headset. Microphone 52 interfaces through boom 54 with a microphone jack assembly 56 that has a standard 3.5 mm or similar jack end configured to insert into a jack receptacle 60 included in a speaker earcup 64. A key member 58 aligns with a key slot formed at the microphone jack receptacle 60 when boom 54 is aligned with a headband 62 of headset 50. At insertion, as is described below in greater detail, the microphone is commanded to mute. FIG. 2A depicts a detailed view to illustrate that key mechanism 58 inserts into the interior of speaker earcup 64 and the microphone jack engages fully with the microphone jack receptacle 60. In the example embodiment, a counterclockwise rotation of boom 54 engages key member 58 within the interior of speaker earcup 64 so that microphone will not release unless rotated to align with the head strap so that key member 58 can retract through the key slot.

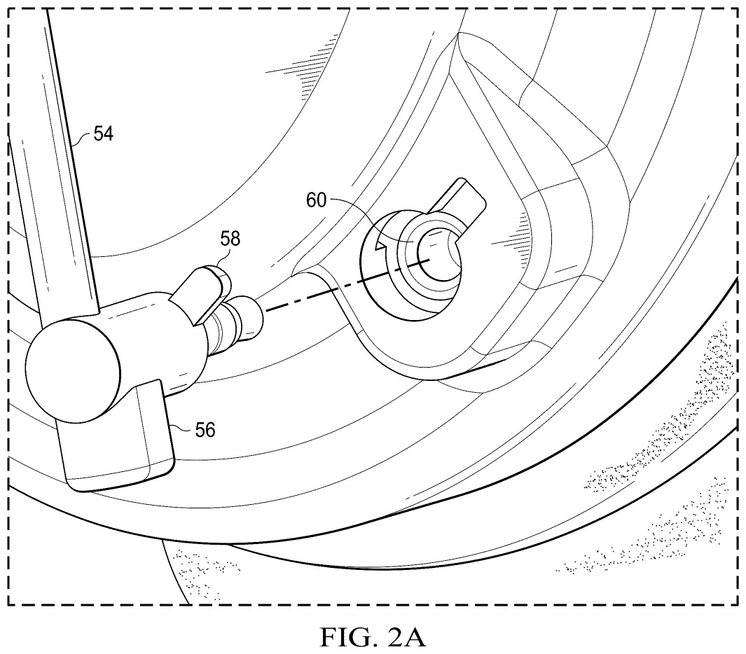

Referring now to FIG. 3, an interior perspective detailed view of speaker earcup 64 depicts microphone jack 70 fully inserted into the microphone jack receptacle. Microphone jack assembly 56 has had key member 58 insert through the key slot to engage in a key member guide 72 by rotating the boom from the insertion position parallel with the headband to a speaking position at the end user's mouth. In the engaged position, microphone jack 70 is retained in the microphone jack receptacle by key member 58 working in key member guide 72. To remove the microphone boom, rotation in a counterclockwise direction to a position parallel with the headband aligns the key member 58 with the key slot so that the microphone jack may be pulled out. Key member guide 72 limits the downward rotation of the boom so that the microphone at the lowest position aligns with the end user's mouth.

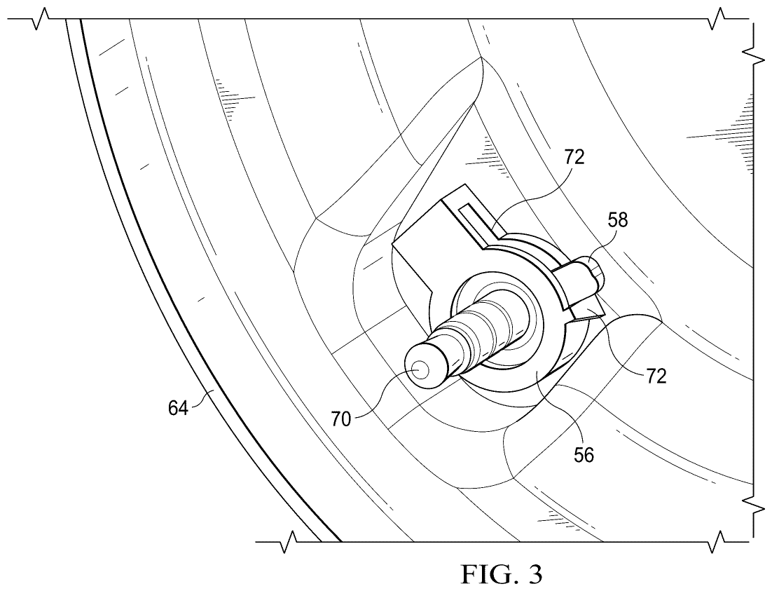

Referring now to FIG. 4, a side view depicts an example embodiment having key member 58 leveraged to detect microphone boom rotational orientation to command mute and unmute. In the example embodiment, a leaf switch 76 coupled to a circuit board 80 in the speaker earcup has a leaf switch lever 78 that is raised to deactivate the switch and lowered to activate the switch based on interaction with key member 58. When the boom 54 is aligned with the headstrap at initial insertion of the jack assembly 70 into the jack receptacle 74, the leaf switch lever 78 is raised by interaction with key member 58 so that the switch is not activated, thereby removing power from the microphone to mute the microphone. After microphone boom 54 rotates a predetermined amount, such as from a 12 o'clock position to a position between 930 to 730 o'clock, leaf switch lever 78 is lowered to activate the switch and thereby turn power on for the microphone.

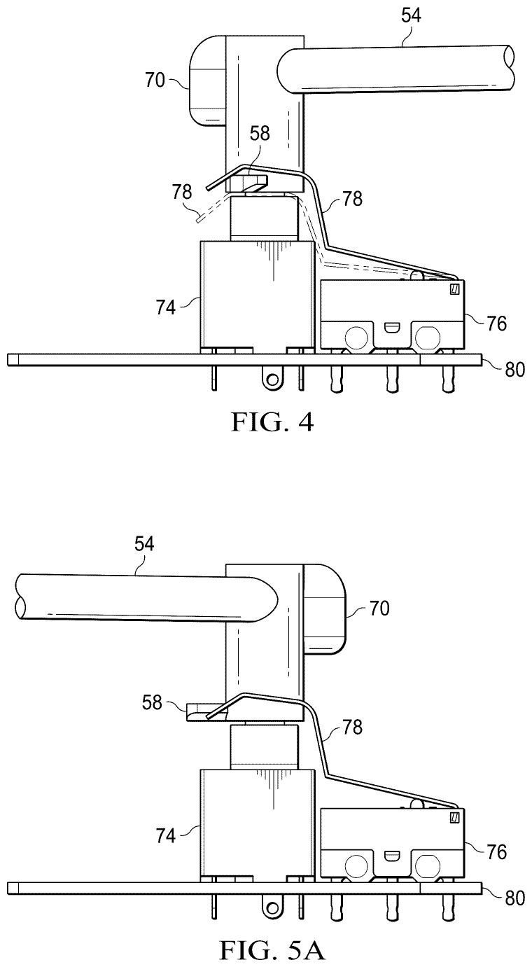

Referring now to FIGS. 5A, 5B and 5C, side views depict activation of the leaf switch 76 by engagement of leaf switch lever 78 with key member 58. FIG. 5A depicts microphone boom 54 in the 12 o'clock position aligned with the headstrap so that key member 58 is not engaged with leaf switch lever 78, which biases to a raised position, so that leaf switch 76 on circuit board 80 does not activate power to the microphone jack receptacle 74 and microphone jack assembly 70. FIG. 5B depicts microphone boom 54 rotation to the 21:30 o'clock position so that key member 58 engages against and pushes down switch lever 78 to turn on power to leaf switch 76, thereby providing power to the microphone jack receptacle 74 and microphone jack assembly 70 to unmute the microphone. FIG. 5C depicts full downward rotation of microphone boom 54 to the 19:30 o'clock position having leaf switch lever 78 pressed down to continue activation of power and maintain unmute at the microphone.

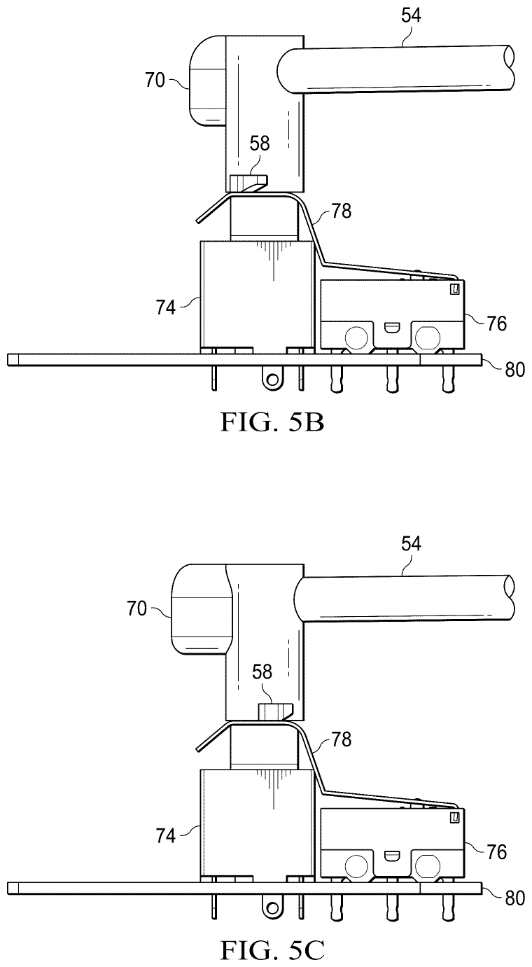

Referring now to FIG. 6, a top view depicts an alternative embodiment for monitoring microphone boom 54 position to manage microphone mute and unmute with an optical sensor 82. Optical sensor 82 is aligned to detect key member 58 when microphone boom 54 rotates to a lowered position in a rotational orientation associated with unmute. At initial insertion, optical sensor 82 does not sense key member 58 so that microphone jack assembly 70 is not provided power and the microphone is muted. As microphone boom 54 rotates to an unmute range, optical sensor 82 detects key member 58 and commands power to microphone jack assembly 70 to unmute the microphone.

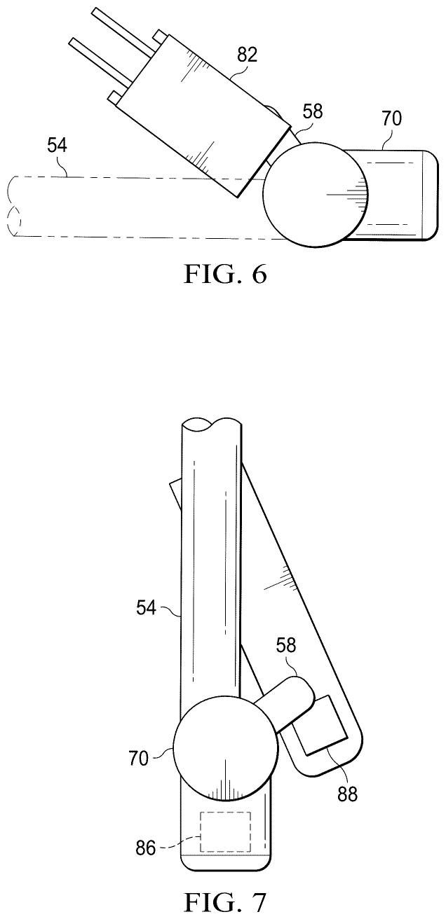

Referring now to FIG. 7, a top view depicts an alternative embodiment for monitoring microphone boom 54 position to manage microphone mute and unmute with a magnet 86 and a Hall sensor 88. As microphone boom 54 rotates, magnet 86 at the end of microphone boom 54 rotates around microphone jack assembly 70 to align with Hall sensor 88, which detects the magnet to command unmute of the microphone.

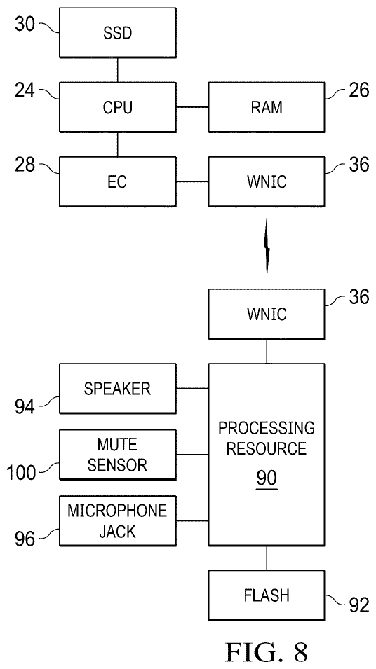

Referring now to FIG. 8, a logical block circuit diagram depicts cooperation of components in the information handling system and headset to manage microphone mute and unmute. CPU 24 executes instructions in cooperation with RAM 26, such as a gaming application retrieved from SSD 30. Embedded controller 28 manages interactions with the headset through wireless signals communicated by WNIC 36. A processing resource 90 in the headset manages communication by WNIC 36 with instructions executed from non-transitory memory of flash 92. During normal operations, audio communicated from CPU 24 is played by a speaker 94 and sounds captured by microphone jack 96 are communicated to CPU 24. When mute sensor 100 detects an unmute command, microphone jack 96 has the audio captured with power supplied by command of processing resource 90. When mute sensor 100 detects that the microphone boom has rotated to a mute position, processing resource may mute the microphone by cutting off power or stopping the communication of audio captured by the microphone. In addition, processing resource 90 sends the mute command to embedded controller 28, which manages the microphone mute state at the information handling system, such as by display mute and unmute states as appropriate. In one embodiment, the mute command by the microphone boom mute position also commands mute of all other microphones associated with the information handling system, such as any integrated microphones. In another example embodiment, an end user may override the mute command by entering an unmute command at the system that is communicated by the embedded controller to the processing resource so that the microphone captures audio even when raised to the mute position. Similarly, the embedded controller may send a mute command input at the information handling system to the processing resource to mute the microphone even though lowered into the unmute position.

Although the present invention has been described in detail, it should be understood that various changes, substitutions and alterations can be made hereto without departing from the spirit and scope of the invention as defined by the appended claims.

What is claimed is:

1. An information handling system comprising:
a housing;
a processor coupled in the housing and operable to execute instructions to process information;
a memory coupled in the housing and interfaced with the processor, the memory operable to store the instructions and information; and
a headset having a speaker ear cup operable to present information as audible sounds, a microphone jack receptacle coupled to the speaker earcup at a key slot formed in the speaker earcup and a microphone boom having a microphone at a first end and a jack at a second end, the jack configured to insert into the microphone jack receptacle, a key member of the jack inserting into the key slot when the microphone boom has a first orientation, the key member engaging with the speaker earcup when rotated from the first position.

2. The information handling system of claim 1 further comprising a key member guide formed at an interior of speaker earcup to define a range of rotation of the microphone boom by interaction with the key member.

3. The information handling system of claim 2 wherein the first position is alignment of the microphone boom with a headband coupled to the earcup.

4. The information handling system of claim 2 further comprising a mute sensor coupled to the interior of the earcup proximate the key slot and operable to mute the microphone from the first position through rotation to a second position and to unmute the microphone from the second position to a third position.

5. The information handling system of claim 4 wherein the mute sensor comprises a leaf switch activated by the key member between the first and second position to command mute and deactivated by rotation of the key member between the second and third position to command unmute.

6. The information handling system of claim 4 wherein the mute sensor comprises an optical sensor aligned to detect the key member between the first and second position to command mute.

7. The information handling system of claim 4 wherein the mute sensor comprises a Hall sensor operable to detect a magnet coupled in the microphone boom.

8. The information handling system of claim 4 further comprising:
a processing resource coupled in the headset and interfaced with the mute sensor; and
a non-transient memory interfaced with the processing resource and storing instructions that when executed on the processing resource cause a cutoff of microphone signals from the headset to the processor when mute is detected at the mute sensor.

9. The information handling system of claim 4 further comprising:
a processing resource coupled in the headset and interfaced with the mute sensor; and
a non-transient memory interfaced with the processing resource and storing instructions that when executed on the processing resource cause communication of a mute command to the processor when mute is detected at the mute sensor.

10. A method for managing a headset microphone boom, the method comprising:
aligning key member formed in an end of the microphone boom with a key slot formed in a speaker earcup of the headset;
inserting a jack of the microphone boom into a jack receptacle of the speaker earcup;
inserting the key member into the key slot; and
rotating the microphone boom to engage the key member in a key member guide within the speaker earcup interior to secure the microphone boom to the speaker earcup.

11. The method of claim 10 further comprising:
aligning the microphone boom with a headband of the headset when the key member aligns with the key slot.

12. The method of claim 10 further comprising:
monitoring a rotational orientation of the microphone boom with a mute sensor;
muting the microphone boom in a first rotational orientation range; and
unmuting the microphone boom in a second rotational orientation range.

13. The method of claim 12 wherein the mute sensor comprises a leaf switch that detects the key member in the first rotational orientation range but not in the second rotational orientation.

14. The method of claim 12 wherein the mute sensor comprises an optical sensor that detects the key member in the first rotational orientation range but not in the second rotational orientation range.

15. The method of claim 12 wherein the mute sensor comprises a Hall sensor that detects a magnet coupled to the microphone boom in the first rotational orientation range but not in the second rotational orientation range.

16. A headset comprising:
a speaker earcup operable to present information as audible sounds;
a microphone jack receptacle coupled to the speaker earcup at a key slot formed in the speaker earcup; and
a microphone boom having a microphone at a first end and a jack at a second end, the jack configured to insert into the microphone jack receptacle;
a key member coupled to the microphone boom proximate the jack and sized to insert into the key slot when the microphone boom has a first orientation, the key member engaging with the speaker earcup when rotated from the first position to retain the microphone boom coupled to the speaker earcup.

17. The headset of claim 16 further comprising:
a key member guide formed at an interior of the speaker earcup to define a range of rotation of the microphone boom by interaction with the key member.

18. The headset of claim 17 further comprising a leaf switch coupled in the speaker earcup and activated by the key member between a first and second rotational position of the microphone boom to command mute and deactivated by rotation of the key member between the second rotational position and a third rotational position to command unmute.

19. The headset of claim 17 further comprising an optical sensor coupled in the speaker earcup and activated by the key member between a first and second rotational position of the microphone boom to command mute and deactivated by rotation of the key member between the second rotational position and a third rotational position to command unmute.

20. The headset of claim 17 further comprising a Hall sensor coupled in the speaker earcup and operable to detect a magnet coupled to the microphone boom between a first and second rotational position of the microphone boom to command mute and deactivated by rotation of the microphone boom between the second rotational position and a third rotational position to command unmute.
